(19) United States
(12) Patent Application Publication
(10) Pub. No.: US 2017/0035064 A1
(43) Pub. Date: Feb. 9, 2017

(54) EDIBLE COMPOSITION FOR FOOD FORMING MACHINE

(71) Applicants: XYZprinting, Inc., New Taipei City (TW); Kinpo Electronics, Inc., New Taipei City (TW); Cal-Comp Electronics & Communications Company Limited, New Taipei City (TW)

(72) Inventor: Wei-Sheng Lee, New Taipei City (TW)

(21) Appl. No.: 14/951,503

(22) Filed: Nov. 25, 2015

(30) Foreign Application Priority Data
Aug. 6, 2015 (CN) 201510475922.2

(51) Int. Cl. A21D 10/04; A23P 1/08

(52) U.S. Cl. CPC A21D 10/04; A23P 1/086; A23P 2001/089; B33Y 70/00

(57) ABSTRACT

The invention provides an edible composition for a food forming machine, including flour, powdered sugar, solidified oil, and liquid. In particular, based on 100 parts by weight of the flour, the content of the powdered sugar is 25 parts by weight to 35 parts by weight, the content of the solidified oil is 45 parts by weight to 60 parts by weight, and the content of the liquid is 25 parts by weight to 35 parts by weight. The edible composition for a food forming machine has excellent three-dimensional forming effect.

### CROSS-REFERENCE TO RELATED APPLICATION

This application claims the priority benefit of Chinese patent application serial no. 201510475922.2, filed on Aug. 6, 2015. The entirety of the above-mentioned patent application is hereby incorporated by reference herein and made a part of the specification.

### BACKGROUND OF THE INVENTION

Field of the Invention

The invention relates to an edible composition, and more particularly, to an edible composition for a food forming machine.

Description of Related Art

With the advance in computer-aided manufacturing (CAM), the manufacturing industry has developed 3D printing technology capable of rapidly fabricating original concept designs. 3D printing technology has an extensive application scope, and in addition to being applied in manufacturing industries and medical fields, 3D printing technology has been further developed and applied in food printing.

However, when 3D printing technology is applied in food printing, issues such as the printed materials are not moldable or poor three-dimensional forming effect often occur. Therefore, how to form materials having excellent three-dimensional forming effect is a focus in the development of current research.

### SUMMARY OF THE INVENTION

The invention provides an edible composition for a food forming machine. The edible composition has excellent three-dimensional forming effect.

The invention provides an edible composition for a food forming machine, including flour, powdered sugar, solidified oil, and liquid. The protein content of the flour is 8.5% or less. In particular, based on 100 parts by weight of the flour, the content of the powdered sugar is 25 parts by weight to 35 parts by weight, the content of the solidified oil is 45 parts by weight to 60 parts by weight, and the content of the liquid is 25 parts by weight to 35 parts by weight.

According to an embodiment of the invention, in the edible composition for a food forming machine, the solidified oil is, for instance, butter, tallow, lard, coconut oil, or a combination thereof.

According to an embodiment of the invention, in the edible composition for a food forming machine, the liquid is, for instance, milk, fruit juice, water, or a combination thereof.

According to an embodiment of the invention, the edible composition for a food forming machine further includes powdered milk, wherein based on 100 parts by weight of the flour, the content of the powdered milk is 4 parts by weight to 6 parts by weight.

According to an embodiment of the invention, the edible composition for a food forming machine further includes cocoa powder, wherein based on 100 parts by weight of the flour, the content of the cocoa powder is 4 parts by weight to 6 parts by weight.

According to an embodiment of the invention, the edible composition for a food forming machine further includes salt, wherein based on 100 parts by weight of the flour, the content of the salt is 1 part by weight to 3 parts by weight.

According to an embodiment of the invention, the edible composition for a food forming machine further includes granulated sugar, wherein based on 100 parts by weight of the flour, the content of the granulated sugar is 4 parts by weight to 6 parts by weight.

According to an embodiment of the invention, the edible composition for a food forming machine further includes an egg, wherein based on 100 parts by weight of the flour, the content of the egg is 20 parts by weight to 30 parts by weight.

According to an embodiment of the invention, in the edible composition for a food forming machine, the food forming machine is, for instance, a three-dimensional forming machine, a clay printer, or an extruding machine.

According to an embodiment of the invention, in the edible composition for a food forming machine, the viscosity of the edible composition is, for instance, 300 centipoise (cp) to 2000 cp.

According to an embodiment of the invention, in the edible composition for a food forming machine, the viscosity of the edible composition is, for instance, 500 cp to 800 cp.

Based on the above, via the components contained in the edible composition for a food forming machine and the content ratio thereof, the edible composition can have excellent three-dimensional forming effect, and therefore after the edible composition is molded by the food forming machine, the edible composition can still maintain the forming shape thereof well.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a picture of a finished product after three-dimensional forming is performed on the edible composition of the experimental example of the invention via a food forming machine;

FIG. 2 is a picture of the finished product of FIG. 1 after baking.

### DESCRIPTION OF THE EMBODIMENTS

First, the edible composition for a food forming machine (also referred to as “edible composition” hereinafter) of the present embodiment is described. The edible composition for a food forming machine of the present embodiment includes flour, powdered sugar, solidified oil, and liquid. The food forming machine suitable for the edible composition is, for instance, a three-dimensional forming machine, a clay printer, or an extruding machine. The content of each component in the edible composition is calculated by setting the content of the flour to 100 parts by weight.

The glutenous property of the flour is decided by the protein content of the flour. In the present embodiment, the protein content of the flour used is 8.5% or less to reduce the glutenous property of the flour. The reason is that, if a flour having excessive glutenous property is used, then when an extruding or molding operation is performed on the edible composition using the food forming machine, the extruded edible composition is readily pulled back into the food forming machine. A flour having a protein content of 8.5% or less can also generally be referred to as low-gluten flour. Moreover, by limiting the content ratio of the flour to within the range of the present embodiment that is setting the content of the flour to 100 parts by weight, the phenomenon of oil-water separation can be reduced, such that the shelf life of the materials can be increased. Moreover, the flour can provide the desired hardness to the edible composition in three-dimensional forming.

In addition to being used as a sweetener, the powdered sugar can further provide the desired hardness to the edible composition for three-dimensional forming, so as to provide a sufficient supporting force to the three-dimensional pattern formed by stacking. Based on 100 parts by weight of the flour, the content of the powdered sugar is 25 parts by weight to 35 parts by weight. In current techniques, granulated sugar is often used to adjust hardness, and although the finished product can be stacked, since granulated sugar contains water, the finished product of the edible composition collapses after baking due to water loss. Therefore, in the present embodiment, by using 25 parts by weight to 35 parts by weight of powdered sugar to replace granulated sugar, sufficient hardness can be provided, such that the finished product can be stacked and the finished product of the edible composition does not readily collapse after baking. As a result, the shape prior to baking can be retained. When the content of the powdered sugar is less than 25 parts by weight, the hardness of the edible composition is insufficient, and the formed finished product cannot be stacked. When the content of the powdered sugar exceeds 35 parts by weight, the hardness of the edible composition is too high, thus generating the issue of difficult extrusion.

In addition to providing the desired softness, bulkiness, and aroma to the edible composition, the solidified oil can also provide the desired viscosity to the edible composition for three-dimensional forming. The viscosity is another key characteristic of three-dimensional forming. During the molding of the edible composition, a layer needs to be first adhered to a substrate, then the material of the second layer is stacked on the first material, and then the edible composition is stacked upward layer by layer. If the viscosity of the edible composition is insufficient, then the first layer cannot be smoothly adhered on the substrate, such that the first layer does not build a good foundation, therefore causing the subsequent portions to not be built properly. Based on 100 parts by weight of the flour, the content of the solidified oil is 45 parts by weight to 60 parts by weight. In the case that the edible composition contains 45 parts by weight to 60 parts by weight of the solidified oil, the edible composition has suitable viscosity. When the content of the solidified oil is less than 45 parts by weight, the viscosity of the edible composition is insufficient, and the formed finished product cannot be adhered and stacked. When the content of the solidified oil exceeds 60 parts by weight, the viscosity of the edible composition is too strong and the materials are too soft such that the edible composition cannot be stacked, and the finished product may even readily collapse after baking due to excessive bulkiness. The solidified oil is, for instance, butter, tallow, lard, coconut oil, or a combination thereof.

The liquid can provide the desired fluidity to the edible composition for three-dimensional forming. Based on 100 parts by weight of the flour, the content of the liquid is 25 parts by weight to 35 parts by weight. In the case that the edible composition contains 25 parts by weight to 35 parts by weight of the liquid, the edible composition has suitable fluidity. When the content of the liquid is less than 25 parts by weight, the fluidity of the edible composition is insufficient, thus generating the issue of difficult extrusion. When the content of the liquid exceeds 35 parts by weight, the fluidity of the edible composition is too high, such that the edible composition readily falls apart and cannot be stacked properly. The liquid is, for instance, milk, fruit juice, water, or a combination thereof. When the added liquid is milk or fruit juice, in addition to providing fluidity, the desired aroma can also be provided.

Moreover, the edible composition can further optionally include at least one of powdered milk, cocoa powder, salt, granulated sugar, and an egg.

The powdered milk can provide the desired aroma and color to the edible composition, and can balance acid-base value. Based on 100 parts by weight of the flour, the content of the powdered milk is 4 parts by weight to 6 parts by weight. In the case that the edible composition contains 4 parts by weight to 6 parts by weight of the powdered milk, the edible composition has suitable aroma, color, and acid-base value.

The cocoa powder can provide the desired aroma and color to the edible composition. Based on 100 parts by weight of the flour, the content of the cocoa powder is 4 parts by weight to 6 parts by weight. In the case that the edible composition contains 4 parts by weight to 6 parts by weight of the cocoa powder, the edible composition has suitable aroma and color.

In addition to balancing sweetness and performing seasoning, the salt can also strengthen the hardness of the edible composition. Based on 100 parts by weight of the flour, the content of the salt is 1 part by weight to 3 parts by weight. In the case that the edible composition contains 1 part by weight to 3 parts by weight of the salt, the edible composition can balance sweetness, and the hardness of the edible composition can also be strengthened.

In addition to being used as a sweetener, the granulated sugar can also strengthen the hardness of the edible composition. Based on 100 parts by weight of the flour, the content of the granulated sugar is 4 parts by weight to 6 parts by weight. In the case that the edible composition contains 4 parts by weight to 6 parts by weight of the granulated sugar, the hardness of the edible composition can be strengthened.

The egg can provide the desired bulkiness, aroma, and color to the edible composition, and can strengthen the viscosity of the edible composition. The bulkiness here refers to that the egg may generate voids inside the finished product after baking, such that the finished product has better taste after baking. Based on 100 parts by weight of the flour, the content of the egg is 20 parts by weight to 30 parts by weight. In the case that the edible composition contains 20 parts by weight to 30 parts by weight of the egg, the edible composition has the desired bulkiness, aroma, and color, and can strengthen the viscosity of the edible composition. When the content of the egg is less than 20 parts by weight, the bulkiness of the edible composition is insufficient, and the finished product is very hard and is substantially solid after baking, such that the taste is poor. When the content of the egg exceeds 30 parts by weight, the bulkiness of the edible composition is too high, such that the finished product expands too much after baking and causes deformation as a result. Moreover, the egg can also provide the desired fluidity to the edible composition for three-dimensional forming. Moreover, the egg can be replaced by, for instance, whole egg powder or yolk powder. When the egg is replaced by, for instance, whole egg powder or yolk powder, the amount of liquid (such as pure water or milk) needs to be increased accordingly to maintain the fluidity and viscosity of the dough.

Moreover, the viscosity of the edible composition is, for instance, 300 centipoise (cp) to 2000 cp, and this viscosity range is a printable viscosity. In an embodiment, the viscosity of the edible composition can be 500 cp to 800 cp, and the edible composition can be extruded by applying a suitable pressure within the viscosity range, and the forming strength of the edible composition is adequate.

It can be known from the above embodiments that, since the edible composition for a food forming machine includes flour, powdered sugar, solidified oil, and liquid in specific contents, the edible composition can have excellent three-dimensional forming effect, and therefore after the edible composition is molded by the food forming machine, the edible composition can still maintain the formed shape thereof well.

In the following, the formula and the preparation method of the edible composition for a food forming machine are illustrated by an experimental example.

I. Formula

The edible composition formula of the present experimental example is as shown in Table 1 below.

TABLE 1

| Classification | Material | Weight (g) | Parts by weight |
|---|---|---|---|
| A materials | Powdered sugar | 60 | 30 |
| | Castor sugar | 10 | 5 |
| | (granulated sugar) | | |
| | Salt | 2 | 1 |
| | Butter | 100 | 50 |
| B materials | Egg | 50 | 25 |
| C materials | Low-gluten flour | 200 | 100 |
| | (protein content of 8.5% | | |
| | or less) | | |
| | Powdered milk (or other | 10 | 5 |
| | colored powders) | | |
| D materials | Milk | 50 | 25 |
| | Total | 482 | 241 |

II. Preparation Method

The A materials are weighed, and the butter needs to be thawed. The powdered sugar in the A material is sieved on a baking paper. The baking paper is folded to pour the powdered sugar into a mixing bowl. The rest of the A materials is put into the mixing bowl and beated. If a mixer is used, the mixture is first stirred at slow speed for 1 minute, and then the mixture is stirred at medium speed for 3 minutes, and a rubber scraper is used to uniformly stir the bottom portion. The B material (egg) is first uniformly mixed and stirred, and the egg needs to be thawed. The B materials are added into the mixing bowl in 3 batches, and the mixture is stirred until completely uniform. The C materials (low-gluten flour (protein content of 8.5% or less) and powdered milk) are weighed. The C materials are sieved on a baking paper. The C materials and the D materials (milk) are added into the mixing bowl, and the mixture is uniformly stirred at slow speed to form a batter.

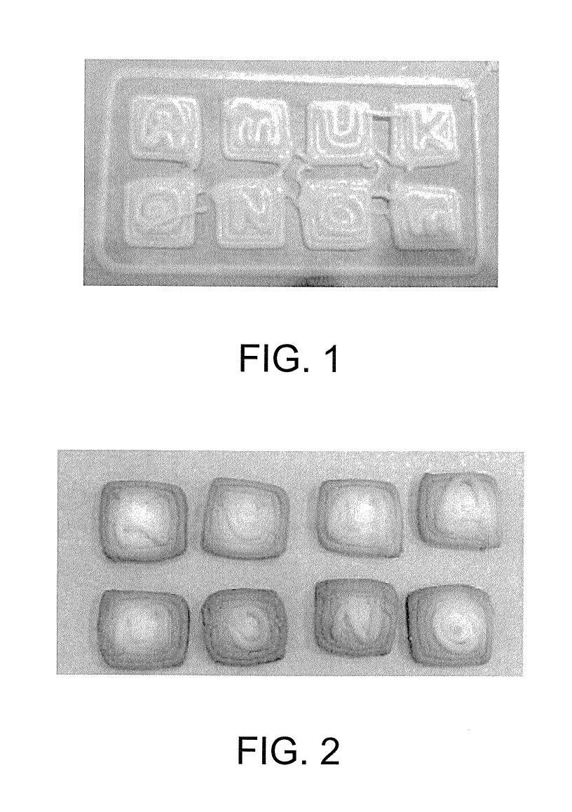

FIG. 1 is a picture of a finished product after three-dimensional forming is performed on the edible composition of the experimental example of the invention via a food forming machine.

It can be known from FIG. 1 that, since the batter formed by the edible composition of the above experimental example has excellent three-dimensional forming effect, after the batter is molded by the food forming machine to form a finished product of cookie word cards, the finished product can maintain the formed cookie word card shape well.

FIG. 2 is a picture of the finished product of FIG. 1 after baking.

It can be known from FIG. 2 that, after the batter of the cookie word card shape formed in the above experimental example is baked, the baked finished product can also have a good three-dimensional cookie word card shape.

Based on the above, the edible composition for a food forming machine in the above embodiments has excellent three-dimensional forming effect, and therefore after the edible composition is molded by the food forming machine, the edible composition can still maintain the formed shape thereof well.

Lastly, it should be mentioned that: each of the above embodiments is only used to describe the technical solutions of the invention and is not intended to limit the invention; and although the invention is described in detail via each of the above embodiments, those having ordinary skill in the art should understand that: modifications can still be made to the technical solutions recited in each of the above embodiments, or portions or all of the technical features thereof can be replaced to achieve the same or similar results; the modifications or replacements do not make the nature of corresponding technical solutions depart from the scope of the technical solutions of each of the embodiments of the invention.

What is claimed is:

1. An edible composition for a food forming machine, comprising:
a flour, wherein a protein content of the flour is 8.5% or less;
a powdered sugar;
a solidified oil; and
a liquid, wherein
based on 100 parts by weight of the flour, a content of the powdered sugar is 25 parts by weight to 35 parts by weight, a content of the solidified oil is 45 parts by weight to 60 parts by weight, and a content of the liquid is 25 parts by weight to 35 parts by weight.

2. The edible composition for a food forming machine of claim 1, wherein the solidified oil comprises butter, tallow, lard, coconut oil, or a combination thereof.

3. The edible composition for a food forming machine of claim 1, wherein the liquid comprises milk, fruit juice, water, or a combination thereof.

4. The edible composition for a food forming machine of claim 1, further comprising a powdered milk, wherein based on 100 parts by weight of the flour, a content of the powdered milk is 4 parts by weight to 6 parts by weight.

5. The edible composition for a food forming machine of claim 1, further comprising a cocoa powder, wherein based on 100 parts by weight of the flour, a content of the cocoa powder is 4 parts by weight to 6 parts by weight.

6. The edible composition for a food forming machine of claim 1, further comprising a salt, wherein based on 100 parts by weight of the flour, a content of the salt is 1 part by weight to 3 parts by weight.

7. The edible composition for a food forming machine of claim 1, further comprising a granulated sugar, wherein based on 100 parts by weight of the flour, a content of the granulated sugar is 4 parts by weight to 6 parts by weight.

8. The edible composition for a food forming machine of claim 1, further comprising an egg, wherein based on 100 parts by weight of the flour, a content of the egg is 20 parts by weight to 30 parts by weight.

9. The edible composition for a food forming machine of claim 1, wherein the food forming machine comprises a three-dimensional forming machine, a clay printer, or an extruding machine.

10. The edible composition for a food forming machine of claim 1, wherein a viscosity of the edible composition is 300 centipoise to 2000 centipoise.

11. The edible composition for a food forming machine of claim 10, wherein a viscosity of the edible composition is 500 centipoise to 800 centipoise.
